(19) United States
(12) Patent Application Publication
(10) Pub. No.: US 2024/0402313 A1
(43) Pub. Date: Dec. 5, 2024

(54) DISTANCE MEASUREMENT DEVICE AND APPARATUS

(71) Applicant: CANON KABUSHIKI KAISHA, Tokyo (JP)

(72) Inventors: TAKASHI OKAMURA, Tokyo (JP); SATOSHI OMODANI, Tokyo (JP)

(21) Appl. No.: 18/677,189

(22) Filed: May 29, 2024

(30) Foreign Application Priority Data
May 30, 2023 (JP) 2023-089115

(51) Int. Cl. G01S 7/486; G01S 7/4863; G01S 17/10

(52) U.S. Cl. CPC G01S 7/4868; G01S 7/4863; G01S 17/10

(57) ABSTRACT

A distance measurement device is provided. The distance measurement device includes: a light source; a photoelectric converter; an optical system configured to form, on the photoelectric converter, an image of a target object receiving light emitted by the light source; and a calculator configured to obtain information of a distance to the target object based on an electrical signal photoelectrically converted by the photoelectric converter. The distance measurement device further comprising a focus driver configured to control focus driving of the optical system. The focus driver performs focus driving to make a depth of field of the optical system fall within a search range of the target object in a period in which a distance measurement operation of measuring a distance to the target object is performed.

### BACKGROUND

### Field of the Invention

The present disclosure relates to a distance measurement device and an apparatus.

### Description of the Related Art

There is known a Time of Flight (ToF) distance measurement device that measures a distance by detecting light emitted from a light source and reflected by a target object. US-2017-0052065 discloses a distance measurement device using a single photon avalanche diode (SPAD) to increase the time resolution.

It is difficult for the ToF distance measurement device to perform high-precision distance measurement on a target object present at an out-of-focus distance because the boundary (edge) of the object blurs. If a lens with a large f-number (aperture value) is used to expand an in-focus range (depth of field), the quantity of light received by a sensor and the distance measurement precision decrease.

### SUMMARY

Some embodiments of the present disclosure provide a technique advantageous in improving the distance measurement precision.

According to some embodiments, a distance measurement device comprising: a light source; a photoelectric converter; an optical system configured to form, on the photoelectric converter, an image of a target object receiving light emitted by the light source; and a calculator configured to obtain information of a distance to the target object based on an electrical signal photoelectrically converted by the photoelectric converter, the distance measurement device further comprising: a focus driver configured to control focus driving of the optical system, wherein the focus driver performs focus driving to make a depth of field of the optical system fall within a search range of the target object in a period in which a distance measurement operation of measuring a distance to the target object is performed, is provided.

Further features of the present invention will become apparent from the following description of exemplary embodiments (with reference to the attached drawings).

### BRIEF DESCRIPTION OF THE DRAWINGS

FIG. 1 is a block diagram showing an arrangement example of a distance measurement device according to an embodiment;

FIG. 2 is a block diagram showing an arrangement example of the light receiver of the distance measurement device in FIG. 1;

FIG. 3 is a block diagram showing an arrangement example of the pixel of the distance measurement device in FIG. 1;

FIG. 4 is a timing chart showing the time gate ToF exposure timing of the distance measurement device in FIG. 1;

FIG. 5 is a view showing the relationship between the target object and the depth of field of the distance measurement device in FIG. 1;

FIG. 6 is a timing chart showing focus driving of the distance measurement device in FIG. 1;

FIG. 7 is a view for explaining the depth of field of the distance measurement device in FIG. 1;

FIG. 8 is a graph showing the relationship between the in-focus position and the depth of field of the distance measurement device in FIG. 1;

FIG. 9 is a timing chart showing focus driving of the distance measurement device in FIG. 1;

FIG. 10 is a timing chart showing focus driving of the distance measurement device in FIG. 1;

FIG. 11 is a block diagram showing a modification of the distance measurement device in FIG. 1;

FIG. 12 is a block diagram showing an arrangement example of the light receiver of the distance measurement device in FIG. 11;

FIG. 13 is a block diagram showing an arrangement example of the pixel of the distance measurement device in FIG. 11;

FIG. 14 is a timing chart showing focus driving of the distance measurement device in FIG. 11; and

FIG. 15 is a view showing an arrangement example of an equipment incorporating the distance measurement device in FIG. 1.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

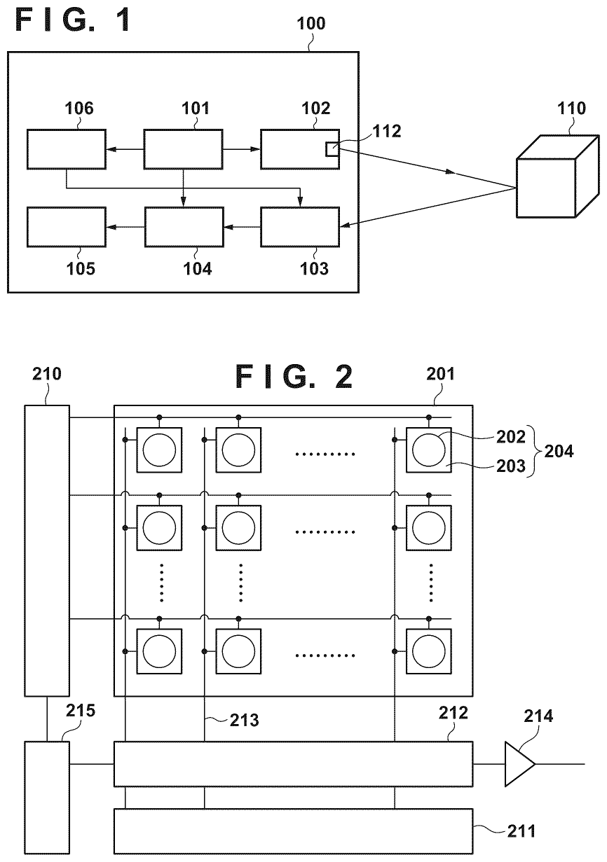

A distance measurement device according to the present disclosure will be explained with reference to FIGS. 1 to 14. FIG. 1 is a block diagram schematically showing an arrangement example of a distance measurement device 100 according to the embodiment. As shown in FIG. 1, the distance measurement device 100 includes a timing controller 101, a light emitter 102, an optical system 103, a light receiver 104, a calculator 105, and a focus driver 106.

The timing controller 101 controls the operation timing of each building component arranged in the distance measurement device 100. More specifically, the timing controller 101 outputs to the light emitter 102 a control signal for controlling the timing when the light emitter 102 emits light. The timing controller 101 outputs to the light receiver 104 a control signal for controlling the timing when the light receiver 104 performs an exposure operation. Further, the timing controller 101 outputs to the focus driver 106 a control signal for controlling the timing when the focus driver 106 performs focus driving.

The light emitter 102 includes a light source 112 that emits light based on the control signal from the timing controller 101. As the light source 112, for example, a semiconductor laser diode is used. In this case, the light source 112 emits a laser beam having a predetermined pulse width in accordance with the control signal supplied from the timing controller 101. An optical member (not shown) such as a diffuser is arranged in the light emitter 102, and light emitted from the light source 112 is diffused to irradiate a predetermined two-dimensional range.

The optical system 103 forms, on a photoelectric converter arranged in the light receiver 104, an image of a target object 110 irradiated with light emitted from the light source 112 of the light emitter 102. The optical system 103 is constituted by, for example, one or more lenses. It can be said that the optical system 103 forms, on the light receiver 104, an image of light emitted from the light source 112 of the light emitter 102 and reflected by the target object 110.

The light receiver 104 includes a so-called image sensor. The light receiver 104 may be, for example, a CMOS sensor or a SPAD sensor using an avalanche photodiode (to be also referred to as an APD hereinafter). The light receiver 104 converts an optical image formed by the optical system 103 into an electrical signal.

The calculator 105 is arranged to obtain information of a distance to the target object 110 based on an electrical signal photoelectrically converted by the photoelectric converter arranged in the light receiver 104. The calculator 105 may generate a three-dimensional distance image from the obtained distance information. For the calculator 105, a semiconductor device such as a CPU or an ASIC may be used.

The focus driver 106 controls focus driving of the optical system 103. Focus driving is driving for focusing on an image formed on the light receiver 104 by the optical system 103. For example, focus driving can be driving of changing the virtual subject distance of the optical system 103. The subject distance is a distance from the front principal point of the optical system 103 to a subject. Since a subject (target object 110) does not always exist in the distance measurement range of the distance measurement device 100, the subject distance is expressed as a “virtual” subject distance. The focus driver 106 performs focus driving so that the depth of field of the optical system 103 falls within, for example, the search range (measurement distance as a target: target measurement distance) of a target object that is determined by the exposure timing of the light receiver 104. The focus driver 106 can include, for example, a motor that moves the lens of the optical system 103 or the like.

FIG. 2 is a block diagram showing an arrangement example of the light receiver 104 according to the embodiment. The light receiver 104 includes a photoelectric converter 201, a control pulse generation circuit 215, a vertical scanning circuit 210, a horizontal scanning circuit 211, a readout circuit 212, signal lines 213, and an output circuit 214.

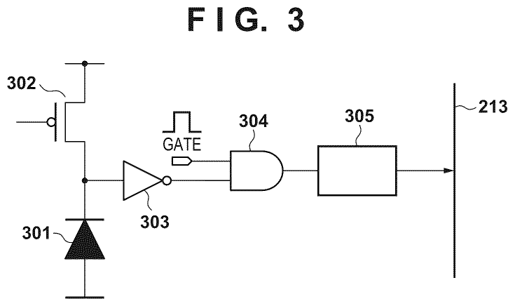

In the photoelectric converter 201, a plurality of pixels 204 are arranged in a two-dimensional array (rows and columns). Each pixel 204 includes a photoelectric conversion circuit 202 and a pixel circuit 203. In the embodiment, the photoelectric conversion circuit 202 includes an APD as a photoelectric conversion element, which will be described lager with reference to FIG. 3. In the embodiment, the pixel 204 arranged in the photoelectric converter 201 includes the photoelectric conversion circuit 202 and the pixel circuit 203. However, the arrangement is not limited to this and it suffices to at least arrange APDs in a two-dimensional array in the photoelectric converter 201. Light entering the photoelectric converter 201 is converted into an electrical signal by the pixel 204 arranged in the photoelectric converter 201. The pixel circuit 203 outputs to the signal line 213 the electrical signal photoelectrically converted by the photoelectric conversion circuit 202.

The vertical scanning circuit 210 supplies a control pulse to each pixel 204 in accordance with a control pulse supplied from the control pulse generation circuit 215. A logic circuit such as a shift register or an address decoder may be used for the vertical scanning circuit 210.

A signal output from the photoelectric conversion circuit 202 of each pixel 204 is processed by the pixel circuit 203. A counter circuit, a memory, and the like may be provided in the pixel circuit 203. A case in which the pixel circuit 203 includes a memory will be explained. The memory holds a digital value.

The horizontal scanning circuit 211 supplies, to the pixel circuit 203, a control pulse for sequentially selecting the pixels 204 arranged in the photoelectric converter 201 for respective columns in order to read out signals from the memories of the pixels 204 that hold digital signals. For a selected column, a signal is output to the signal line 213 from the pixel circuit 203 of the pixel 204 selected by the vertical scanning circuit 210. The signal output to the signal line 213 is output to the calculator 105 via the output circuit 214.

In the arrangement shown in FIG. 2, the pixels 204 are arranged in a two-dimensional array in the photoelectric converter 201. However, the arrangement is not limited to this, and the pixels 204 may be arranged one-dimensionally in the photoelectric converter 201. Alternatively, only a single pixel 204 may be arranged in the photoelectric converter 201.

The function of the pixel circuit 203 need not always be provided one by one in all the pixels 204. For example, one pixel circuit 203 may be shared between the plurality of pixels 204 to sequentially perform signal processing.

FIG. 3 is a block diagram showing an arrangement example of the pixel 204 according to the embodiment. As described above, the pixel 204 includes the photoelectric conversion circuit 202 and the pixel circuit 203. In the arrangement shown in FIG. 3, an APD 301 is used as the photoelectric conversion circuit 202. The pixel circuit 203 includes a quench element 302, a waveform shaping circuit 303, a gate element 304, and a light quantity value holding circuit 305. The light quantity value holding circuit 305 is equivalent to the memory of the above-described pixel circuit 203.

The APD 301 is connected to the quench element 302 that controls an avalanche current. A photon detection signal output from the APD 301 via the waveform shaping circuit 303 is temporally controlled by a gate signal GATE input to the gate element 304. An output from the gate element 304 is input to the light quantity value holding circuit 305.

The APD 301 generates a charge pair corresponding to incident light by photoelectric conversion. A potential based on a potential VH higher than a potential VL supplied to the anode of the APD 301 is supplied to the cathode. The potentials VH and VL are supplied between the anode and cathode of the APD 301 to apply such a reverse bias that causes avalanche multiplication on photons entering the APD 301. When photoelectric conversion is performed in a state in which the reverse bias is supplied, charges generated by incident light cause avalanche multiplication in the APD 301, generating an avalanche current.

When the potential difference (voltage) between the anode and the cathode is larger than a breakdown voltage in a case where the reverse bias voltage is supplied, the APD 301 performs a Geiger mode operation. The APD 301 that quickly detects a faint signal of a single photon level using the Geiger mode operation is sometimes called a Single Photon Avalanche Diode (SPAD). Although the SPAD is used to quickly detect a faint signal in the embodiment, the operation mode of the APD 301 may be a linear mode operation in which avalanche multiplication is caused at a voltage equal to or smaller than the breakdown voltage.

The quench element 302 has a function of converting a change of the avalanche current generated in the APD 301 into a voltage signal. If the photocurrent is multiplied by avalanche multiplication in the APD 301, a current obtained by multiplied charges flows to a connection node between the APD 301 and the quench element 302. A voltage drop caused by the current decreases the potential of the cathode of the APD 301, and the APD 301 does not form an electron avalanche. As a result, the avalanche multiplication of the APD 301 stops. Then, the potential VH of the power supply is supplied to the cathode of the APD 301 via the quench element 302, and the potential supplied to the cathode of the APD 301 returns to the potential VH. That is, the operation region of the APD 301 returns again to the Geiger mode operation. In this manner, the quench element 302 functions as a load circuit (quench element) at the time of multiplying charges by avalanche multiplication, and operates to suppress avalanche multiplication (quench operation). After suppressing avalanche multiplication, the quench element 302 operates to return the operation region of the APD 301 again to the Geiger mode (recharge operation).

For the waveform shaping circuit 303, for example, an inverter circuit is used. The waveform shaping circuit 303 shapes a potential change of the cathode of the APD 301 obtained at the time of photon detection, and outputs a pulse signal.

For the gate element 304, for example, an AND circuit is used. By controlling the High/Low level of the gate signal GATE, the gate element 304 adjusts a period in which the exposure operation of the pixel 204 is performed. The period in which the exposure operation is performed is a period in which photon detection is possible in the APD 301, and a period in which a pulse signal obtained by converting a potential change of the APD 301 by the waveform shaping circuit 303 is output to the light quantity value holding circuit 305. A period in which no exposure operation is performed in the pixel 204 is called a non-exposure period. The non-exposure period is a period in which no pulse signal is output from the waveform shaping circuit 303 to the light quantity value holding circuit 305. In FIG. 3, a time during which the gate signal GATE is at the High level is the period in which the exposure operation is performed, and a time during which the gate signal GATE is at the Low level is the non-exposure period.

The light quantity value holding circuit 305 is connected to the signal line 213 so as to output a signal. Based on a signal value (electrical signal) output from the light quantity value holding circuit 305, the calculator 105 can obtain information of a distance to the target object 110 and perform distance measurement. The signal line 213 is constituted by at least such a number of lines as to output signals by the number of bits output from the light quantity value holding circuit 305.

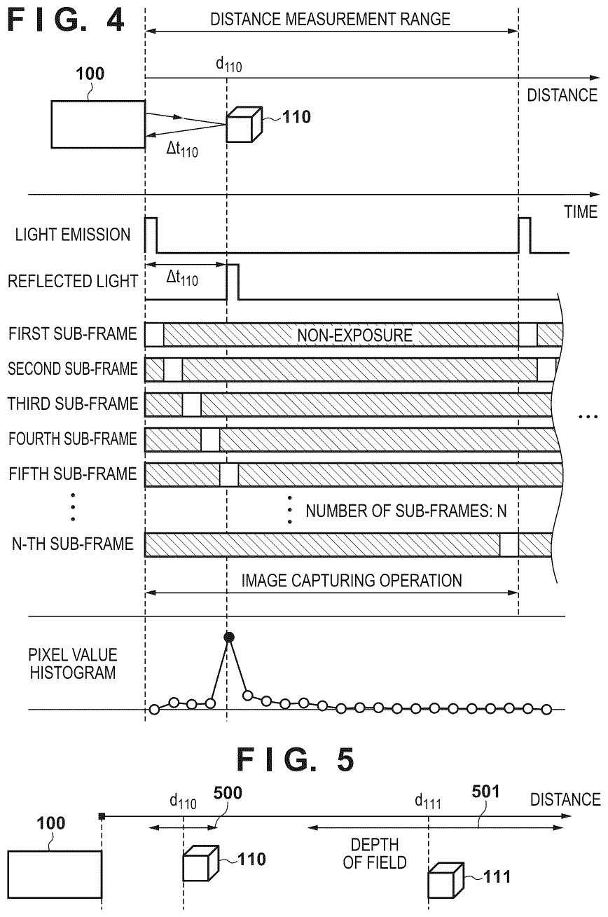

FIG. 4 is a timing chart showing a time gate ToF exposure timing according to the embodiment. In the embodiment, an image capturing operation is performed for a plurality of frames while changing the time until the pixel 204 arranged in the photoelectric converter 201 performs the exposure operation after light emission of the light source 112 in a period in which the distance measurement operation of measuring a distance up to the target object 110 is performed once. In FIG. 4, each frame in which the image capturing operation is performed is defined as a sub-frame.

In FIG. 4, a range represented by white in each sub-frame is a period in which the exposure operation is performed in the photoelectric converter 201 (pixel 204), and a range represented by black is a non-exposure period. In FIG. 4, a plurality of sub-frames are aligned for one light emission to clarify the relationship between the distance from the distance measurement device 100 and the time until reflected light is detected after light emission. In actual driving, however, reflected light in the first sub-frame is detected upon the first light emission. Then, reflected light in the second sub-frame is detected upon the second light emission. Reflected light in the Nth sub-frame is detected upon the Nth light emission. That is, the image capturing operation (light emission and detection of reflected light) is performed in series in order from the first sub-frame to the Nth sub-frame. Upon completion of the image capturing operation from the first sub-frame to the Nth sub-frame, one distance measurement frame can be obtained, completing one distance measurement operation. After that, for example, a similar operation is repeated. In the embodiment, electrical signals can be output from the respective pixels 204 in respective image capturing operations (sub-frames).

Reflected light detection is performed N times while relatively shifting the start timing when the exposure operation is performed and the end timing with respect to the light emission timing of the light source 112 arranged in the light emitter 102. That is, the photon quantity (pixel value) of the search range (target measurement distance) in each image capturing operation (sub-frame) can be obtained for a predetermined distance measurement range by detecting reflected light while shifting little by little the start timing when the exposure operation is performed, and performing linear scanning. The distance measurement device 100 can perform distance measurement in this way by performing a plurality of image capturing operations different in the standby time until the photoelectric converter 201 performs the exposure operation after light emission of the light source 112.

FIG. 4 shows only one light emission and one exposure operation for each image capturing operation (sub-frame). However, distance measurement may be performed by adding signals obtained by repeating each image capturing operation a plurality of times. This can improve the precision of detection of reflected light. In the example shown in FIG. 4, the standby time until the photoelectric converter 201 performs the exposure operation after light emission of the light source 112 is controlled to be longer than that of an immediately preceding image capturing operation (sub-frame) in each of image capturing operations (sub-frames). Distance measurement is performed while shifting the exposure timing in a direction from a short distance to a long distance. However, distance measurement is not limited to this and may be performed while shifting the exposure timing in a direction from a long distance to a short distance.

In the example shown in FIG. 4, light reflected by the target object 110 is received in the exposure operation of the fifth sub-frame (in other words, the fifth image capturing operation in one distance measurement operation). In the remaining sub-frames, no target object exists, so no reflected light is detected. The calculator 105 can obtain distance information by detecting the peak of a pixel value histogram obtained from the photon quantity (pixel value: electrical signal) of each image capturing operation (sub-frame) output from the light quantity value holding circuit 305.

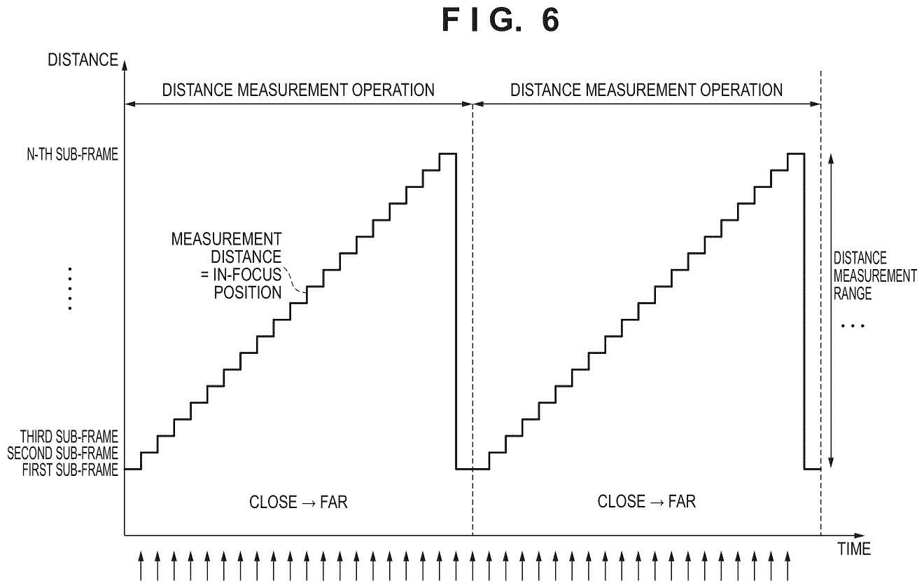

Next, the operation of the focus driver 106 will be explained with reference to FIGS. 5 and 6. As shown in FIG. 5, the target object 110 is arranged at a distance d₁₁₀ from the distance measurement device 100, and a target object 111 is arranged at a distance d₁₁₁ farther than the distance d₁₁₀. A depth of field 500 is a depth of field when the focus is adjusted to the distance d₁₁₀. A depth of field 501 is a depth of field when the focus is adjusted to the distance d₁₁₁. Assume that the target objects 110 and 111 do not overlap each other in the distance direction when viewed from the distance measurement device 100 (they can be seen from the distance measurement device 100).

When the range of a distance including the target objects 110 and 111 is measured, if the focus is adjusted to the distance d₁₁₀ of the target object 110, the target object 111 behind the depth of field 500 is defocused and an image of the target object 111 blurs (so-called defocusing). If the focus is adjusted to the distance d₁₁₁ of the target object 111, the target object 110 ahead of the depth of field 501 is defocused and an image of the target object 110 blurs. Although not shown, even if the focus is set at a position between the distances d₁₁₀ and d₁₁₁, neither the target object 110 nor the target object 111 falls within the depth of field and at least either of them is defocused. In such a case, it is difficult to measure the distance range including the target objects 110 and 111 in a state in which the virtual subject distance (in-focus position) of the optical system 103 is fixed. It is necessary to increase the f-number of the lens and widen the depth of field. However, if the f-number of the lens is increased, the quantity of reflected light received by the light receiver 104 decreases and the distance measurement precision decreases. To solve this, according to the embodiment, the focus driver 106 performs focus driving in a period in which the distance measurement operation is performed to measure a distance to the target object 110 or 111.

FIG. 6 shows an in-focus position by focus driving with respect to the time axis. The in-focus position is a position at the virtual subject distance from the front principal point of the distance measurement device 100. In the following description, the in-focus position and the virtual subject distance have similar meanings. At timings indicated by ↑ aligned along the abscissa (time axis), the timing controller 101 shifts the exposure timing in the direction from a short distance to a long distance, and the image capturing operation is performed from the first sub-frame (shortest distance) to the Nth sub-frame (longest distance), as shown in FIG. 4. The focus driver 106 performs focus driving to change the virtual subject distance in accordance with a measurement distance determined by the standby time until the photoelectric converter 201 performs the exposure operation after light emission of the light source 112 in each of image capturing operations. For example, the focus driver 106 changes the in-focus position so that the virtual subject distance becomes equal to the search range (target measurement distance) uniquely determined by the exposure timing. As shown in FIG. 6, the focus driver 106 may perform focus driving so that the virtual subject distance changes intermittently in accordance with each of image capturing operations in a plurality of sub-frames. Upon completion of the image capturing operation in the Nth sub-frame, the image capturing operation returns to the image capturing operation in the first sub-frame in the next distance measurement operation, and a similar operation is performed.

As described with reference to FIG. 4, in the time gate ToF method, a distance (search range or target measurement distance) measured by one image capturing operation is determined in advance regardless of the presence/absence of a target object (for example, the target object 110 or 111), and the exposure timing is controlled in accordance with the search range of the target object. Focus driving is performed so that the search range coincides with the in-focus position. The image capturing operation is performed in a state in which the focus is adjusted to all search ranges and thus the distance can be measured.

In the above-described way, the focus driver 106 performs focus driving in a period in which the distance measurement operation is performed to measure a distance to a target object. The ToF distance measurement can be performed while adjusting the in-focus position to a measurement distance determined by the standby time until the photoelectric converter 201 performs the exposure operation after light emission of the light source 112 in each image capturing operation. As a result, high-precision distance measurement becomes possible without blurring (defocusing) the edge of a target object in a wide distance measurement range.

In the above-described embodiment, the description has been made in which the focus driver 106 changes the virtual subject distance so that the in-focus position is adjusted to a measurement distance determined by the standby time until the photoelectric converter 201 performs the exposure operation after light emission of the light source 112. However, as long as the measurement distance determined by the standby time till the exposure operation after light emission falls within the depth of field of the optical system 103, even if the focus is not adjusted to the measurement distance, an image does not blur and the distance measurement precision is less likely to decrease.

In the embodiment, therefore, the focus driver 106 changes the virtual subject distance so that the measurement distance determined by the standby time till the exposure operation after light emission falls within the front depth of field at a short distance and the rear depth of field at a long distance. The change amount of the virtual subject distance by focus driving decreases, and the load of the optical system 103 can be reduced.

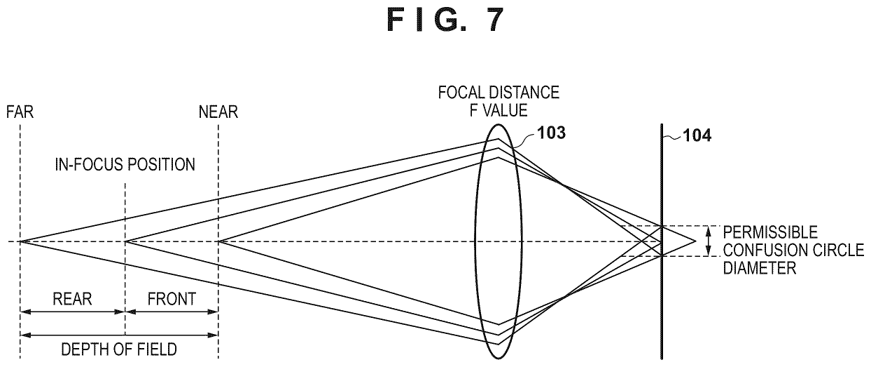

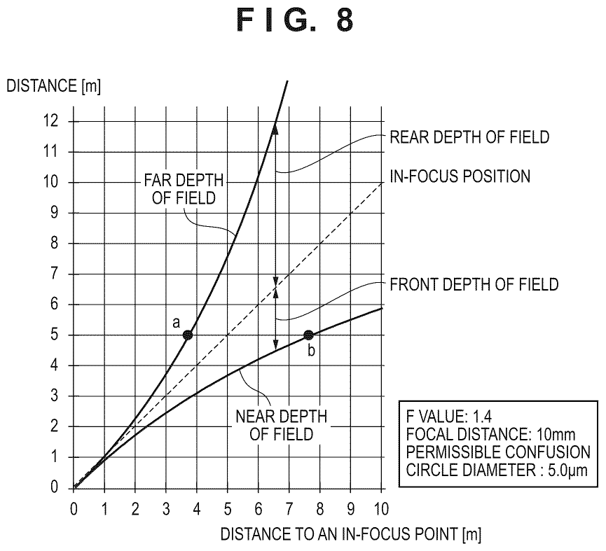

An embodiment considering the depth of field of an optical system 103 will be described with reference to FIGS. 7 to 9. The arrangement of the distance measurement device 100 described with reference to FIGS. 1 to 4 is similarly applied to this embodiment, so a description thereof will be omitted here and a difference from the operation of a focus driver 106 from that described with reference to FIG. 6 will be mainly described in detail.

FIG. 7 is a view for explaining the depth of field. The depth of field is a range in which the focus seems to be adjusted, and there are the front depth of field and the rear depth of field before and after the in-focus position. The front depth of field and the rear depth of field can be obtained by the following equations in which units other than that of the f-number are units of the length and are, for example, millimeters (mm):

$$\\ \begin{matrix}front depth of field \approx ( \begin{matrix}permissible confusion circle diameter \times \\ f ‐ number \times in ‐ focus point {distance}^{{}_{} 2}\end{matrix} ) / ( \begin{matrix}focal {distance}^{{}_{} 2} + permissible confusion circle diameter \times \\ f ‐ number \times in ‐ focus point distance\end{matrix} ) & ( 1 )\end{matrix}$$

$$\\ \begin{matrix}rear depth of field \approx ( \begin{matrix}permissible confusion circle diameter \times \\ f ‐ number \times in ‐ focus point {distance}^{{}_{} 2}\end{matrix} ) / ( \begin{matrix}focal {distance}^{{}_{} 2} - permissible confusion circle diameter \times \\ f ‐ number \times in ‐ focus point distance\end{matrix} ) & ( 2 )\end{matrix}$$

$$\\ \begin{matrix}depth of field = front depth of field + rear depth of field & ( 3 )\end{matrix}$$

FIG. 8 shows the relationship between the in-focus point distance and the depth of field when the focus distance of the lens is 10 mm, the permissible confusion circle diameter is 5 μm, and the f-number is 1.4. For example, a case in which an image capturing operation is performed at a measurement distance of 5 m that is determined by the standby time till the exposure operation after light emission is considered. In this case, when the in-focus point distance is adjusted to a point a of 3.7 m, the far depth of field becomes 5 m, and when the in-focus point distance is adjusted to a point b of 7.6 m, the near depth of field becomes 5 m. That is, when the in-focus point distance is adjusted within the range of 3.7 m to 7.6 m, the measurement distance of 5 m falls within the depth of field and measurement distance can be performed without blurring an image.

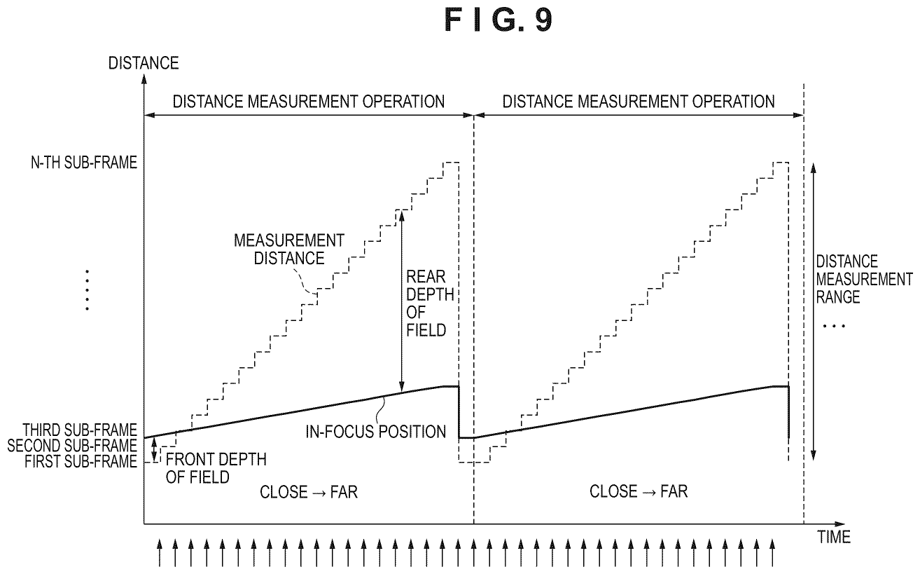

FIG. 9 is a view for explaining an example of focus driving of the focus driver 106 according to the embodiment. A dotted line represents a measurement distance determined by the standby time till the exposure operation after light emission, and a solid line represents an in-focus position by focus driving. Similar to the example shown in FIG. 6, the measurement distance is shifted at a predetermined interval in the direction from a short distance to a long distance. In contrast, the in-focus position is not adjusted to the measurement distance. At a short distance, the focus is adjusted behind the target measurement distance so that the measurement distance falls within the front depth of field. At a long distance, the focus is adjusted ahead of the measurement distance so that the measurement distance falls within the rear depth of field. That is, when the standby time till the exposure operation after light emission is controlled to be longer than that of an immediately preceding image capturing operation in each of image capturing operations, it is set that a measurement distance determined by the standby time in the first image capturing operation among a plurality of image capturing operations falls within the front depth of field of the in-focus position of an optical system 103 in the first image capturing operation, and a measurement distance determined by the standby time in the final image capturing operation among the plurality of image capturing operations falls within the rear depth of field of the in-focus position of the optical system 103 in the final image capturing operation. As shown in FIG. 9, the focus driver 106 performs focus driving so as to continuously change the virtual subject distance (in-focus position).

As described above, focus control is performed so that the measurement distance determined by the standby time till the exposure operation after light emission falls within the depth of field. Accordingly, a change amount for adjusting the focus of the optical system 103 becomes smaller than that shown in FIG. 6, and the load of the optical system 103 can be decreased.

The focus driver 106 performs focus driving so as to continuously change the virtual subject distance (in-focus position) in the operation shown in FIG. 9, but may perform focus driving so as to intermittently change the virtual subject distance, as shown in FIG. 6. The measurement distance determined by the standby time till the exposure operation after light emission may be shifted at a predetermined interval in the direction from a long distance to a short distance. That is, when the standby time till the exposure operation after light emission is controlled to be shorter than that of an immediately preceding image capturing operation in each of image capturing operations, it may be set that a measurement distance determined by the standby time in the first image capturing operation among a plurality of image capturing operations falls within the rear depth of field of the in-focus position of the optical system 103 in the first image capturing operation, and a measurement distance determined by the standby time in the final image capturing operation among the plurality of image capturing operations falls within the front depth of field of the in-focus position of the optical system 103 in the final image capturing operation. The focus driver 106 may perform focus driving so as to continuously or intermittently change the virtual subject distance (in-focus position).

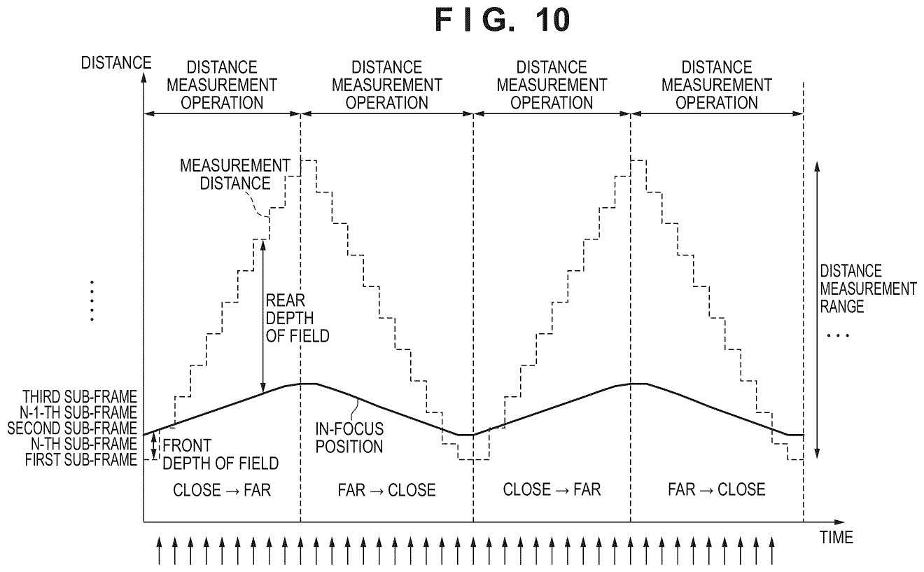

In the operation shown in FIG. 9, the focus driver 106 adjusts the focus so that the measurement distance determined by the standby time till exposure after light emission falls within the front depth of field at a short distance and the rear depth of field at a long distance, thereby reducing the load of the optical system 103. However, similar to the operation shown in FIG. 6, a distance is measured in the direction from a short distance to a long distance in each image capturing operation (sub-frame) in the distance measurement operation. When returning the in-focus position from a long distance to a short distance between distance measurement operations, the change amount of the in-focus position of the optical system 103 becomes large and the load of the optical system 103 may increase. To prevent this, as shown in FIG. 10, the distance measurement order in the distance measurement operation may be changed to decrease the change amount of the focus position between distance measurement operations and reduce the load of the optical system 103.

In the operations shown in FIGS. 6 and 9, the measurement distance determined by the standby time till exposure after light emission in each distance measurement operation is measured in order in the direction from a short distance to a long distance. More specifically, distance ranges in which a distance can be measured in respective image capturing operations shown in FIG. 4 are defined as D₁, D₂, D₃, . . . , and D_{N} in order from the first sub-frame. In this case, in the operations shown in FIGS. 6 and 9, the in-focus position is changed between image capturing operations in the order of D₁, D₂, D₃, . . . , and D_{N} (close→far). To the contrary, in the operation shown in FIG. 10, the in-focus position is changed in the order of D₁, D₃, D₅, . . . , D_{N-1}, D_{N}, D_{N-2}, . . . , D₆, D₄, and D₂ (close→far→close) (in this example, N is an even number). When the distance measurement operation shifts to the next one between distance measurement operations, the measurement distance changes from the longest distance to the shortest distance (D_{N}→D₁) in the operations shown in FIGS. 6 and 9, but changes to an adjacent distance (D_{N-1}→D_{N} or D₂→D₁) in the operation shown in FIG. 10. In other words, a plurality of distance measurement operations include first and second successive distance measurement operations. When the standby time till exposure after light emission is controlled to be longer than that of an immediately preceding image capturing operation in each of image capturing operations in the first distance measurement operation, the standby time is controlled to be shorter than that of an immediately preceding image capturing operation in each of image capturing operations in the second distance measurement operation. Also, when the standby time till exposure after light emission is controlled to be shorter than that of an immediately preceding image capturing operation in each of image capturing operations in the first distance measurement operation, the standby time is controlled to be longer than that of an immediately preceding image capturing operation in each of image capturing operations in the second distance measurement operation.

In FIG. 10, a dotted line represents a measurement distance determined by the standby time till the exposure operation after light emission, and a solid line represents an in-focus position by focus driving. As described above, the light emission and exposure timings are controlled so that a distance is measured in order from a short distance to a long distance or from a long distance to a short distance within the distance measurement operation. The in-focus position changes in accordance with the order of the measurement distance. In this case, the focus driver 106 may perform focus driving so that the measurement distance falls within the depth of field of the in-focus position, similar to the operation shown in FIG. 9. This can decrease the change amount of the in-focus position. However, focus driving is not limited to this and may be performed so that a focal distance determined by the standby time till the exposure operation after light emission coincides with the in-focus position, as shown in FIG. 6.

In the operation shown in FIG. 10, the image capturing operation (sub-frame) performed in one distance measurement operation is half the operation shown in FIG. 6 or 9. However, the operation is not limited to this. For example, distance ranges in which a distance can be measured in the first distance measurement operation are represented as D₁, D₂, D₃, . . . , and D_{N} in order from the first sub-frame. Then, distance ranges in which a distance can be measured in the second distance measurement operation are represented as D_{N}, D_{N-1}, D_{N-2}, . . . , and D₁ in order from the first sub-frame. Distance measurement similar to the first distance measurement operation may be performed in the third distance measurement operation, distance measurement similar to the second distance measurement operation may be performed in the fourth distance measurement operation, and similar distance measurement operations may be repeated subsequently.

In this manner, the light emission and exposure timings and focus driving are controlled based on such a distance measurement order as to decrease the change amount of the in-focus position in focus driving between distance measurement operations, as shown in FIG. 10. This can further reduce the load of the optical system 103, compared to the operations shown in FIGS. 6 and 9.

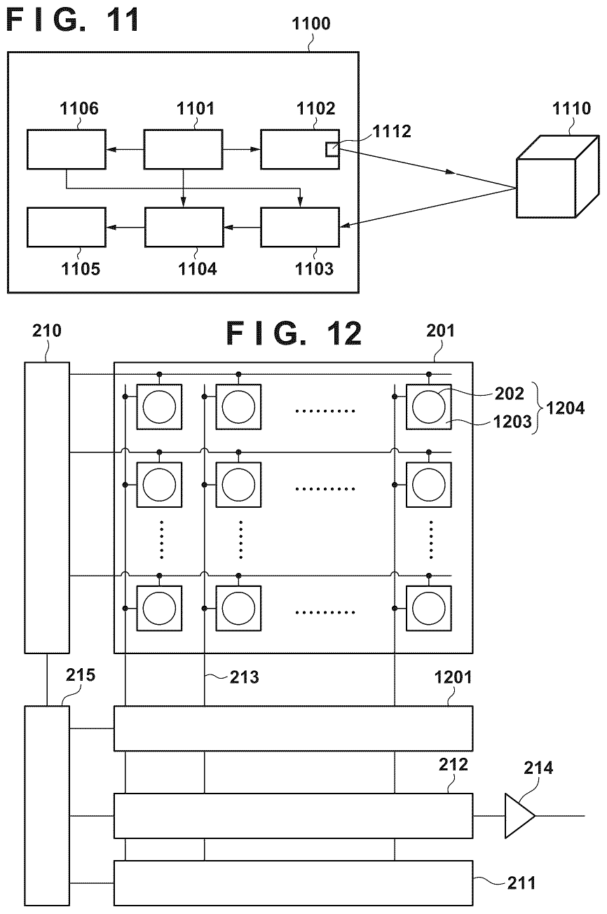

In the above-described embodiments, the distance measurement device 100 using the time gate ToF method has been exemplified. In the following embodiment, an example in which focus driving is performed in a direct ToF distance measurement device 1100 will be explained with reference to FIGS. 11 to 14.

In the direct ToF method, a flight time until reflected light is received after emission of a laser beam is directly measured to calculate a distance to a target object 1110. In the direct ToF method, electrical signals are output once from a plurality of pixels 1204 arranged in a photoelectric converter 201 of a light receiver 104 in one distance measurement operation, and flight times (=distances) different between the pixels 1204 are measured. Unlike the above-mentioned time gate ToF method, no measurement distance is determined in advance at the start of the distance measurement operation. However, a distance to be measured is sometimes determined in advance in accordance with a region within the image capturing range. In such a case, according to the embodiment, focus driving is performed to change the virtual subject distance in accordance with a position at which the pixel 1204 of the photoelectric converter 201 is arranged, thereby expanding the distance measurement range and improving the distance measurement precision.

FIG. 11 is a block diagram schematically showing an arrangement example of the distance measurement device 1100 according to the embodiment. The block arrangement of the distance measurement device 1100 is similar to the arrangement shown in FIG. 1, and includes a timing controller 1101, a light emitter 1102, an optical system 1103, a light receiver 1104, a calculator 1105, and a focus driver 1106.

The timing controller 1101 controls the operation timing of each building component arranged in the distance measurement device 1100. More specifically, the timing controller 1101 outputs to the light emitter 1102 a control signal for controlling the timing when the light emitter 1102 emits light. The timing controller 1101 outputs, to a Time-to-Digital Converter (TDC) 1201 (to be described later) arranged in the light receiver 1104, a control signal for controlling the timing when the TDC 1201 starts time measurement. Further, the timing controller 1101 outputs to the focus driver 1106 a control signal for controlling the timing when the focus driver 1106 performs focus driving.

The light emitter 1102 includes a light source 1112 that emits light based on the control signal from the timing controller 1101. As the light source 1112, for example, a semiconductor laser diode is used. In this case, the light source 1112 emits a laser beam having a predetermined pulse width in accordance with a control signal supplied from the timing controller 1101. Light emitting elements corresponding to one row of the pixels 1204 arranged in the photoelectric converter 201 may be arranged in the light emitter 1102 (light source 1112). One-dimensional distance information is obtained by one image capturing operation (light emission→light reception) corresponding to one light emission of the light emitter 1102. Two-dimensional distance information can be obtained by scanning, one by one in the vertical direction, pixel rows in which the image capturing operation is performed. That is, in the distance measurement operation, the distance measurement device 1100 performs the image capturing operation to measure, for each row of the pixels 1204, the time until reflected light is detected after light emission of the light source 1112. To remove the influence of noise such as extraneous light, the distance measurement operation may be performed a plurality of times to generate one distance measurement data. Irradiation with a laser beam may be raster scanning of two-dimensional scanning in the horizontal and vertical directions, or a flash method of irradiating a two-dimensional range by one image capturing operation, similar to the above-described light emitter 102.

The optical system 1103 forms, on the photoelectric converter 201 arranged in the light receiver 104, an image of the target object 1110 receiving light emitted from the light source 1112 of the light emitter 1102. The optical system 1103 is constituted by, for example, one or more lenses. It can be said that the optical system 1103 forms, on the light receiver 104, an image of light emitted from the light source 1112 of the light emitter 1102 and reflected by the target object 1110.

The light receiver 1104 includes a so-called image sensor. The light receiver 1104 may be, for example, a CMOS sensor or a SPAD sensor. The light receiver 1104 converts an optical image formed by the optical system 1103 into an electrical signal. Based on the electrical signal, the TDC 1201 (to be described later) measures the time till reception of reflected light after light emission of the light source 1112, and converts the time into a digital value.

The calculator 1105 generates a histogram from time measurement values that are obtained a plurality of times for the respective pixels 1204 and output from the TDC 1201 of the light receiver 1104. Based on a time measurement value serving as a peak and the velocity of light, the calculator 1105 obtains information of a distance to the target object 1110. The calculator 1105 may generate a three-dimensional distance image from the obtained distance information. For the calculator 1105, a semiconductor device such as a CPU or an ASIC may be used.

The focus driver 1106 controls focus driving of the optical system 1103. The focus driver 1106 performs focus driving so that a predetermined search range (target measurement distance) of a target object falls within the depth of field of the optical system 1103 in accordance with the position at which the pixels 1204 are arranged in the photoelectric converter 201 of the light receiver 1104.

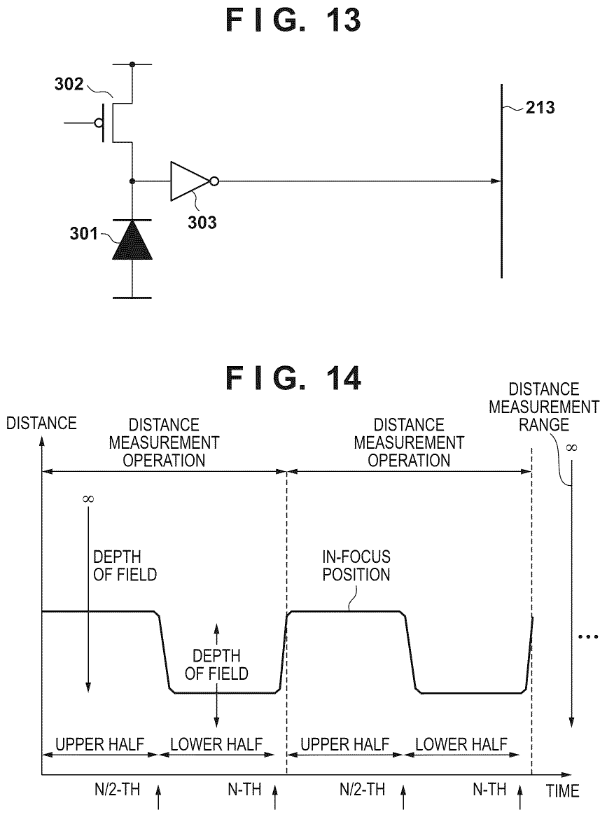

FIG. 12 is a block diagram showing an arrangement example of the light receiver 1104 according to the embodiment. FIG. 13 is a block diagram showing an arrangement example of the pixel 1204 according to the embodiment. The same reference numerals as those in FIGS. 2 and 3 denote components that can be similar to those in FIGS. 2 and 3, and a description thereof will be properly omitted.

The light receiver 1104 shown in FIG. 12 is different from the arrangement shown in FIG. 2 in the arrangement of the pixel 1204 and in that the light receiver 1104 includes the TDC 1201. In the pixel 1204 shown in FIG. 13, the gate element 304 and the light quantity value holding circuit 305 are deleted from the pixel circuit 203 shown in FIG. 3. A pulse signal output from a waveform shaping circuit 303 in response to detection of reflected light is input to the TDC 1201 via a signal line 213.

The TDC 1201 starts time measurement (counter operation) in synchronization with a time measurement start signal synchronized with the light emission timing of the light source 1112 of the light emitter 1102 output from the timing controller 1101. The TDC 1201 stops the time measurement (counter operation) in response to the pulse signal arising from the detection of reflected light, and can measure the flight time until reflected light is received upon emission of a laser beam. The measured time measurement value is output to the calculator 1105 via an output circuit 214.

FIG. 14 shows an example of focus driving according to the embodiment. For example, for an onboard camera, the in-focus position (position at which the focus is adjusted) is far on the upper side of the image capturing range and near on the lower side. Considering this, the operation shown in FIG. 14 represents an example in which the in-focus position is changed between the upper and lower halves of the pixels 204 arranged in the photoelectric converter 201 and distance measurement is performed.

In the operation shown in FIG. 14, the focus driver 1106 sets the virtual subject distance (in-focus position) to be the first distance during the first to N/2th rows as the upper half of the photoelectric converter 201 on which an image capturing operation of performing time measurement is performed first. Then, the focus driver 1106 sets the virtual subject distance (in-focus position) to be the second distance shorter than the first distance during the N/2+1th to Nth rows as the lower half of the photoelectric converter 201 on which the image capturing operation is performed next. The Nth row is a row on which the image capturing operation is finally performed in the distance measurement operation. In FIG. 14, the focus driver 1106 performs focus driving at timings indicated by ↑. The respective in-focus positions (first and second distances) are determined so that target distance measurement ranges determined in advance in accordance with the arrangements (upper and lower halves) of the pixels 1204 in the photoelectric converter 201 fall within the depth of field.

In the embodiment, focus driving of two in-focus positions is performed in the distance measurement operation, but focus driving is not limited to this. As long as a distance measurement range corresponding to the arrangement of the pixels 1204 arranged in the photoelectric converter 201 is determined in advance, focus driving may be performed at three or more in-focus positions in respective distance measurement operations. Even the arrangement positions of the pixels 1204 in the photoelectric converter 201 at which the in-focus position is changed are not particularly limited.

As described above, focus driving is performed in the distance measurement device 1100 using the direct ToF method. Expansion of the distance measurement range and improvement of the distance measurement precision are implemented not only in the distance measurement device 100 using the time gate ToF method but also in the distance measurement device 1100 using the direct ToF method.

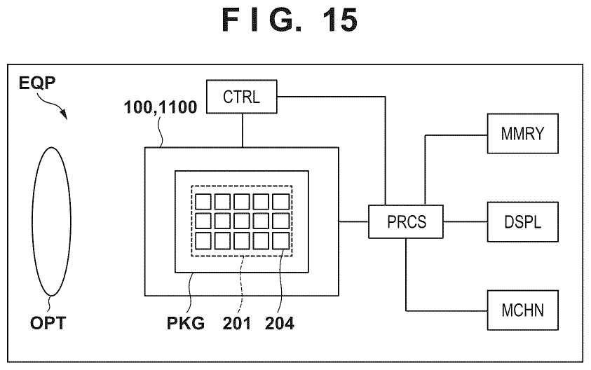

An application example of the distance measurement device 100 or 1100 according to the embodiment described above will be described below. FIG. 15 is a schematic view of electronic equipment EQP incorporating the distance measurement device 100 or 1100. The distance measurement device 100 or 1100 can be a semiconductor chip with a stacked structure including the photoelectric converter 201 in which the pixels 204 are arranged. As shown in FIG. 15, the distance measurement device 100 or 1100 is contained in a semiconductor package PKG. The package PKG can include a base to which the distance measurement device 100 or 1100 is fixed, a lid such as glass facing the distance measurement device 100 or 1100, and a conductive connecting member such as a bonding wire or bump used to connect a terminal provided on the base to a terminal provided on the distance measurement device 100 or 1100. The equipment EQP may further include at least one of a control device CTRL, a processing device PRCS, a display device DSPL, and a storage device MMRY.

An optical system OPT includes the above-described optical system 103, forms an image on the photoelectric converter 201, and can be, for example, a lens, a shutter, and a mirror. The control device CTRL controls the operation of the distance measurement device 100 or 1100, and can be, for example, a semiconductor device such as an ASIC or the like. The processing device PRCS processes a signal output from the distance measurement device 100 or 1100, and can be, for example, a semiconductor device such as a CPU, an ASIC, or the like. The display device DSPL can be an EL display device or a liquid crystal display device that displays data obtained by the distance measurement device 100 or 1100. The storage device MMRY is a magnetic device or a semiconductor device for storing data obtained by the distance measurement device 100 or 1100. The storage device MMRY can be a volatile memory such as an SRAM, a DRAM, or the like or a nonvolatile memory such as a flash memory or a hard disk drive. A mechanical device MCHN can include a moving or propulsion unit such as a motor or an engine. The mechanical device MCHN can include the above-described focus driver 106 or 1106 that drives the components of the optical system OPT for zooming, focusing, and shutter operations. In the equipment EQP, data output from the distance measurement device 100 or 1100 is displayed on the display device DSPL, or transmitted to an external device by a communication device (not shown) included in the equipment EQP. Hence, the equipment EQP may also include the storage device MMRY and the processing device PRCS.

The equipment EQP incorporating the distance measurement device 100 or 1100 is also applicable to a surveillance camera or an onboard camera mounted in a transportation equipment such as an automobile, a railroad car, a ship, an airplane, or an industrial robot. In addition, the equipment EQP incorporating the distance measurement device 100 is not limited to transportation equipment but is also applicable to equipment that widely uses object recognition, such as an intelligent transportation system (ITS).

The present disclosure can provide a technique advantageous in improving the distance measurement precision.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-089115, filed May 30, 2023, which is hereby incorporated by reference herein in its entirety.

What is claimed is:

1. A distance measurement device comprising:
a light source; a photoelectric converter;
an optical system configured to form, on the photoelectric converter, an image of a target object receiving light emitted by the light source; and
a calculator configured to obtain information of a distance to the target object based on an electrical signal photoelectrically converted by the photoelectric converter, the distance measurement device further comprising:
a focus driver configured to control focus driving of the optical system,
wherein the focus driver performs focus driving to make a depth of field of the optical system fall within a search range of the target object in a period in which a distance measurement operation of measuring a distance to the target object is performed.

2. The device according to claim 1, wherein the focus driver performs focus driving for change a virtual subject distance.

3. The device according to claim 1, wherein in the distance measurement operation, the distance measurement device performs a plurality of image capturing operations different in a standby time until the photoelectric converter performs an exposure operation after light emission of the light source, and
the focus driver performs focus driving to change a virtual subject distance in accordance with a measurement distance determined by the standby time of each of the plurality of image capturing operations.

4. The device according to claim 3, wherein the focus driver performs focus driving to intermittently change the virtual subject distance in accordance with each of the plurality of image capturing operations.

5. The device according to claim 3, wherein the standby time is controlled to be longer than a standby time in an immediately preceding image capturing operation in each of the plurality of image capturing operations,
a measurement distance determined by the standby time in a first image capturing operation among the plurality of image capturing operations falls within a front depth of field of an in-focus position of the optical system in the first image capturing operation, and
a measurement distance determined by the standby time in a final image capturing operation among the plurality of image capturing operations falls within a rear depth of field of the in-focus position of the optical system in the final image capturing operation.

6. The device according to claim 3, wherein the standby time is controlled to be shorter than a standby time in an immediately preceding image capturing operation in each of the plurality of image capturing operations,
a measurement distance determined by the standby time in a first image capturing operation among the plurality of image capturing operations falls within a rear depth of field of an in-focus position of the optical system in the first image capturing operation, and
a measurement distance determined by the standby time in a final image capturing operation among the plurality of image capturing operations falls within a front depth of field of the in-focus position of the optical system in the final image capturing operation.

7. The device according to claim 3, wherein a plurality of distance measurement operations including the distance measurement operation are performed,
the plurality of distance measurement operations include first and second successive distance measurement operations,
if the standby time is controlled to be longer than a standby time in an immediately preceding image capturing operation in each of the plurality of image capturing operations in the first distance measurement operation, the standby time is controlled to be shorter than a standby time in an immediately preceding image capturing operation in each of the plurality of image capturing operations in the second distance measurement operation, and
if the standby time is controlled to be shorter than a standby time in an immediately preceding image capturing operation in each of the plurality of image capturing operations in the first distance measurement operation, the standby time is controlled to be longer than a standby time in an immediately preceding image capturing operation in each of the plurality of image capturing operations in the second distance measurement operation.

8. The device according to claim 7, wherein in, of the plurality of distance measurement operations, a distance measurement operation in which the standby time becomes longer than a standby time in an immediately preceding image capturing operation in each of the plurality of image capturing operations, a measurement distance determined by the standby time in a first image capturing operation among the plurality of image capturing operations falls within a front depth of field of an in-focus position of the optical system in the first image capturing operation, and a measurement distance determined by the standby time in a final image capturing operation among the plurality of image capturing operations falls within a rear depth of field of the in-focus position of the optical system in the final image capturing operation, and
in, of the plurality of distance measurement operations, a distance measurement operation in which the standby time becomes shorter than a standby time in an immediately preceding image capturing operation in each of the plurality of image capturing operations, the measurement distance determined by the standby time in the first image capturing operation falls within the rear depth of field of the in-focus position of the optical system in the first image capturing operation, and the measurement distance determined by the standby time in the final image capturing operation falls within the front depth of field of the in-focus position of the optical system in the final image capturing operation.

9. The device according to claim 3, wherein a plurality of pixels are arranged in the photoelectric converter, and
in each of the plurality of image capturing operations, the electrical signal is output from each of the plurality of pixels.

10. The device according to claim 9, wherein each of the plurality of pixels includes an avalanche photodiode.

11. The device according to claim 1, wherein a plurality of pixels are arranged in the photoelectric converter,
in the distance measurement operation, the electrical signal is output once from each of the plurality of pixels, and
the focus driver performs focus driving to change a virtual subject distance in accordance with positions at which the plurality of pixels are arranged in the photoelectric converter.

12. The device according to claim 11, wherein the plurality of pixels are arranged to constitute a plurality of rows in the photoelectric converter,
in the distance measurement operation, the distance measurement device performs, for each of the rows of the plurality of pixels, an image capturing operation of measuring a time until reflected light is detected after light emission of the light source,
the focus driver sets the virtual subject distance to be a first distance during a time up to a first row from a row on which the image capturing operation is performed first, and
the focus driver sets the virtual subject distance to be a second distance during a time up to a second row from a row on which the image capturing operation is performed next to the first row.

13. The device according to claim 12, wherein the second row is a row on which the image capturing operation is finally performed in the distance measurement operation.

14. An apparatus comprising:
a distance measurement device comprising:
a light source; a photoelectric converter;
an optical system configured to form, on the photoelectric converter, an image of a target object receiving light emitted by the light source; and
a calculator configured to obtain information of a distance to the target object based on an electrical signal photoelectrically converted by the photoelectric converter, the distance measurement device further comprising:
a focus driver configured to control focus driving of the optical system,
wherein the focus driver performs focus driving to make a depth of field of the optical system fall within a search range of the target object in a period in which a distance measurement operation of measuring a distance to the target object is performed; and
a processing device configured to process a signal output from the distance measurement device.
